(19) United States
(12) Patent Application Publication
(10) Pub. No.: US 2015/0233313 A1
(43) Pub. Date: Aug. 20, 2015

(54) METHOD FOR CALCULATING ENGINE CHARACTERISTIC VARIABLES, DATA PROCESSING SYSTEM AND COMPUTER PROGRAM PRODUCT

(71) Applicant: MTU FRIEDRICHSHAFEN GMBH, Friedrichshafen (DE)

(72) Inventors: Wolfgang Fimml, Friedrichshafen (DE); Philippe Gorse, Friedrichshafen (DE); Andreas Rothmaier, Vaihingen/Enz (DE); Christian Frey, Oberteuringen (DE); Aron Toth, Friedrichshafen (DE); Alexander Bernhard, Meckenbeuren (DE)

(21) Appl. No.: 14/432,564

(22) PCT Filed: Oct. 2, 2013
(86) PCT No.: PCT/EP2013/002968

§ 371 Date: Mar. 31, 2015

(30) Foreign Application Priority Data
Oct. 15, 2012 (DE) 10 2012 020 137.0

(51) Int. Cl. F02D 41/00; F02D 41/04; F02M 37/00

(52) U.S. Cl. CPC F02D 41/0025; F02M 37/0082; F02D 41/008; F02D 41/04; F02D 41/0027

(57) ABSTRACT

A method for operating a reciprocating-piston internal combustion engine, including: supplying a fuel mixture having two fuel types and air into a combustion chamber; burning the fuel mixture in the combustion chamber during a working stroke; detecting the pressure profile in the combustion chamber during the working stroke by one pressure sensor per combustion chamber; determining an amount of energy per working stroke and per combustion chamber from the pressure profile. In order to enable different fuel types and/or fuel qualities to be taken into consideration in the regulation of the engine, the calorific value of the fuel mixture per working stroke and per combustion chamber is determined from the volume and/or the mass of the supplied fuel mixture and from the determined amount of energy per working stroke and per combustion chamber. At least one parameter of the engine is regulated as a function of the calorific value.

The present invention relates to a method for operating a reciprocating piston internal combustion engine as claimed in the preamble of claim 1, and to a reciprocating piston internal combustion engine as claimed in the preamble of claim 10.

Reciprocating piston internal combustion engines are used in mobile applications, for example in motor vehicles, and stationary applications, for example as power generators, and generally have a plurality of combustion chambers which are bounded by an oscillating piston, a cylinder, a combustion chamber wall as well as an inlet valve and an outlet valve. In this context, multi-fuel engines which are operated with different types of fuel and/or fuel quality levels, i.e. mixtures thereof, are also known. The fuels are available as a liquid or as a gas. The fuel is stored in a fuel tank. After fueling with another type of fuel, a mixture is present in the fuel tank. Reciprocating piston internal combustion engines, both with auto-ignition and extraneous ignition, are operated with fuel, for example gasoline, composed of hydrocarbons made of refined crude oil and are increasingly operated with proportions of renewable raw materials in the form of plants. Ethanol or another type of alcohol can be acquired from the plants and added as a second type of fuel to the gasoline as a first type of fuel. If, for example, a residual quantity of gasoline without an ethanol proportion is still present in the fuel tank before the refueling, and gasoline with an ethanol proportion of 15% is fed to the fuel tank, a mixture is obtained of pure gasoline and the gasoline with the ethanol proportion of 15%. Fuel sensors are known which can measure the proportion of ethanol and these fuel sensors are arranged on the fuel tank in such a way that only the proportion of ethanol at the position in the fuel tank at which the fuel sensor is arranged can be detected. Unequal mixture in the fuel tank therefore leads to measurement results of the fuel sensor which does not correspond to the average proportion of ethanol in the fuel tank. In this context during the mixture fluctuations occur in the proportion of ethanol which is fed to injectors on the combustion chambers from the fuel tank through fuel lines. The measurement results of the fuel sensor therefore do not supply the proportion of ethanol in the fuel which is fed to a combustion chamber with the injector.

Reciprocating piston internal combustion engines are operated with different combustion methods and some of these combustion methods, for example RCCI, HCCI (homogenous charge compression ignition) or DCCS, react in an extremely sensitive way to different or fluctuating types of fuel and/or fuel quality levels, with the result that adapted open-loop and/or closed-loop control of the reciprocating piston internal combustion engine as a function thereof is necessary. In the HCCI method, which is generally carried out only in a part of the operating range, the combustion begins simultaneously in the entire combustion chamber, with the result that this combustion method requires particularly accurate open-loop and/or closed-loop control of the parameters of the reciprocating piston internal combustion engine in order to avoid instabilities during the combustion owing to different types of fuel and to be able to use the HCCI method over the largest possible operating range. DE 10 2010 043 966 A1 discloses a method for operating an internal combustion engine in the HCCI operating mode. A profile of a measurement variable is detected in a combustion chamber of a cylinder, and on the basis thereof combustion features of a combustion process in a first combustion cycle are determined. A first value of a state variable is subsequently determined at a defined time after the first combustion cycle and before a second subsequent combustion cycle on the basis of the determined combustion features. In the second, following combustion cycle, setpoint values of the combustion features of the combustion are determined. On the basis of these setpoint values, a second value of the state variable of the second combustion cycle is determined, and the internal combustion engine is actuated as a function of the first and second of the state variables.

DE 10 2004 033 072 A1 presents a method for performing open-loop control of an internal combustion engine, wherein a first variable which characterizes the pressure in the combustion chamber of at least one cylinder is detected with at least one sensor, wherein on the basis of the first variable a second variable, for example the heating profile, which characterizes the energy released during the combustion is determined. When a threshold value of the second variable is exceeded, a third variable is detected.

DE 10 2008 001 668 A1 discloses a method for determining the composition of a fuel mixture from a first fuel and at least a second fuel for operating an auto-ignition internal combustion engine. The internal combustion engine has a sensor for determining the profile of the combustion, for example for determining the cylinder pressure or solid-borne sound signals. A measure of the stability of the combustion process is formed on the basis of a variable characterizing the combustion process in at least one cylinder, and the composition of the fuel mixture is determined on the basis of the measure of the stability.

The object of the present invention is therefore to make available a method for operating a reciprocating piston internal combustion engine and a reciprocating piston internal combustion engine in which different types of fuel and/or fuel quality levels can easily be taken into account during the open-loop and/or closed-loop control of the reciprocating piston internal combustion engine. This object is achieved with a method for operating a reciprocating piston internal combustion engine having the steps: feeding in a fuel mixture composed of at least two types of fuel and air into at least one combustion chamber of the reciprocating piston internal combustion engine, burning the fuel mixture in the at least one combustion chamber during a working stroke, detecting the pressure profile during the working stroke in the at least one combustion chamber of the reciprocating piston internal combustion engine by means of one pressure sensor per combustion chamber, determining one energy variable per working stroke and per combustion chamber from the pressure profile detected by the pressure sensor, in the at least one combustion chamber, wherein the energy variable characterizes the chemical energy which is released during the combustion in the at least one combustion chamber, wherein the volume and/or the mass of the fuel mixture which is fed to the at least one combustion chamber per working stroke and per combustion chamber is detected, and the calorific value of the fuel mixture per working stroke and per combustion chamber is determined from the volume and/or the mass of the fuel mixture and the determined energy variable per working stroke and per combustion chamber, and at least one parameter of the reciprocating piston internal combustion engine is open-loop controlled and/or closed-loop controlled as a function of the determined calorific value per working stroke and per combustion chamber, and this preferably also includes the fact that the proportion of the at least two different types of fuel in the fuel mixture per working stroke and per combustion chamber is determined on the basis of the determined calorific value, and at least one parameter of the reciprocating piston internal combustion engine is open-loop and/or closed-loop controlled as a function of the proportion of the at least two different types of fuel in the fuel mixture per working stroke and per combustion chamber.

Different types of fuel also have different fuel quality levels, with the result that the term type of fuel also includes fuels with different quality levels. Reciprocating piston internal combustion engines can be operated with different types of fuel, for example gasoline and alcohol, in particular ethanol. In this context, controlled open-loop and/or closed-loop control of the parameters of the reciprocating piston internal combustion engine are/is necessary in order to permit, in particular, uniform and precise combustion during the working stroke. As a result, low emissions of pollutants and a high efficiency level can be reached. For different calorific values of the fuel mixture which is fed to the combustion chamber per working stroke, optimized open-loop and/or closed-loop control, adapted thereto, of the parameters of the reciprocating piston internal combustion engine are/is necessary. For example, the opening times of the inlet and outlet valves, the quantity of fuel mixture fed to the combustion chamber, the injection time of the fuel mixture and the ignition time can therefore be open-loop controlled as a function of the calorific value of the fuel mixture, i.e. the average calorific value of the fuel mixture per combustion chamber and per working stroke, in order to obtain the lowest possible emissions of pollutants and a high efficiency level. During operation with different types of fuel, completely homogenous mixture of the types of fuel does not generally take place in the fuel tank, with the result that different mixture ratios of the types of fuel are fed to the combustion chambers. Only by detecting the calorific value per working stroke and per combustion chamber is it possible to open-loop and/or closed-loop control at least one parameter for this combustion chamber separately for each combustion chamber. The fuel mixture is expediently injected with an injector into the at least one combustion chamber or the fuel mixture is fed together with the air to the at least one combustion chamber through an inlet valve on the at least one combustion chamber.

In a further embodiment, the calorific value of the fuel mixture per working stroke and per combustion chamber is determined separately for a plurality of combustion chambers, and at least one parameter of the reciprocating piston internal combustion engine is open-loop and/or closed-loop controlled separately for this respective combustion chamber as a function of the determined calorific values per working stroke and per combustion chamber, of which combustion chamber the calorific value has been determined, and this is carried out for a plurality of combustion chambers. The calorific value of the fuel mixture is determined per working stroke and per combustion chamber, and for those combustion chambers for which the calorific value has been determined at least one parameter of the reciprocating piston internal combustion engine is open-loop and/or closed-loop controlled for these combustion chambers in which the calorific values have been determined. In the case of a reciprocating piston internal combustion engine with four combustion chambers, for example the calorific value for the first and second combustion chambers is determined in the first and second combustion chambers per working stroke, and as a function of the calorific value in the first combustion chamber at least one parameter of the reciprocating piston internal combustion engine is open-loop and/or closed-loop controlled for the first combustion chamber, and as a function of the calorific value in the second combustion chamber at least one parameter of the reciprocating piston internal combustion engine is open-loop and/or closed-loop controlled for the second combustion chamber. The calorific value of the fuel mixture in the second combustion chamber is therefore not used to perform open-loop and/or closed-loop control of at least one parameter of the reciprocating piston internal combustion engine for the first combustion chamber and vice versa.

In a supplementary variant, for all the combustion chambers of the reciprocating piston internal combustion engine the calorific value of the fuel mixture per working stroke and per combustion chamber is determined separately for individual combustion chambers, and at least one parameter of the reciprocating piston internal combustion engine in all the combustion chambers is open-loop and/or closed-loop controlled separately for this respective combustion chamber as a function of the determined calorific values per working stroke and per combustion chamber, of which combustion chamber the calorific value has been determined, and this is carried out for all the combustion chambers. Therefore, in all the combustion chambers of the reciprocating piston internal combustion engine at least one parameter of the reciprocating piston internal combustion engine is open-loop and/or closed-loop controlled in the respective combustion chamber as a function of the calorific value in this combustion chamber, with the result that for all the combustion chambers, i.e. the entire reciprocating piston internal combustion engine, the combustion chambers are open-loop and/or closed-loop controlled in an optimized fashion for the calorific value.

In a further refinement, the reciprocating piston internal combustion engine is operated with auto-ignition of the fuel mixture, in particular with the HCCI method, and/or the reciprocating piston internal combustion engine is operated with the Otto method and/or with gasoline. The reciprocating piston internal combustion engine is expediently operated with the RCCI method and/or the reciprocating piston internal combustion engine is operated with the diesel method and/or operated with diesel fuel. In particular, in the case of operation of the reciprocating piston internal combustion engine with different types of fuel in the HCCI method, differences in the calorific value or in the composition of types of fuel can impede simultaneous auto-ignition in the entire combustion chamber if at least one parameter for a combustion chamber is not adapted and optimized to the calorific value or the composition of the types of fuel in this combustion chamber.

The energy variable is expediently the cumulative combustion profile and/or the cumulative heating profile.

In a further refinement, in order to determine the energy variable, conversion losses and/or wall heat losses are taken into account with models and/or empirical values and/or the combustion chamber wall temperature is detected and taken into account with one wall temperature sensor per combustion chamber, in particular in order to determine the wall heat losses, and/or the data of a heat balance probe or a Hohenberg probe are taken into account. In a further embodiment, on the basis of the calorific value of the fuel mixture per working stroke and per combustion chamber and/or on the basis of the energy variable and the volume and/or the mass of the fuel mixture per working stroke and per combustion chamber the proportion of the at least two different types of fuel in the fuel mixture per working stroke and per combustion chamber is determined separately for at least one combustion chamber, in particular for all the combustion chambers, and as a function thereof at least one parameter of the reciprocating piston internal combustion engine is open-loop and/or closed-loop controlled separately for at least one combustion chamber, in particular all the combustion chambers, of which the proportion of the at least two different types of fuel has been determined. In the case of a fuel mixture with two types of fuel, in which mixture the calorific values of the two types of fuel are known, the proportion of each of the two types of fuel of the fuel mixture can be determined from the average calorific value of the two types of fuel, i.e. of the fuel mixture, and at least one parameter of the reciprocating piston internal combustion engine can be open-loop and/or closed-loop controlled as a function thereof. In a supplementary variant, the volume of the fuel mixture which is fed to the at least one combustion chamber for the working stroke is detected by taking into account and/or detecting the injection time and/or the pressure difference at the injector and/or the viscosity of the fuel mixture and/or the flow cross-sectional area of the injector and/or a volume flow of gaseous fuel mixture and/or inlet times of an inlet valve. The reciprocating piston internal combustion engine has, for example, an injector for injecting the liquid fuel into the combustion chamber during a working stroke, and the volume of the fuel which is fed to the combustion chamber per working stroke and per combustion chamber can be determined on the basis of the injection time and preferably further variables. In this context, empirical assumptions are necessary for many variables, for example the viscosity of the fuel mixture, if measurement is not possible or appropriate during operation.

In a supplementary embodiment, the at least one parameter of the reciprocating piston internal combustion engine, which is open-loop and/or closed-loop controlled, is the opening time of an inlet valve and/or the opening time of an outlet valve and/or the λ value and/or the ignition time and/or the quantity of fuel mixture which is fed to the combustion chamber and/or the quantity of air which is fed to the combustion chamber and/or the injection time of the fuel mixture, wherein this is preferably open-loop and/or closed-loop controlled per combustion chamber and/or per working stroke, in particular separately. The reciprocating piston internal combustion engine has a variable valve drive, with the result that the opening times of the inlet valve and outlet valve can be controlled freely. The λ value can be controlled by means of the quantity of air and the fuel mixture in the combustion chamber per working stroke. In the HCCI method, ignition is carried out without a spark plug with the result that the ignition time cannot be open-loop and/or closed-loop controlled with the spark plug.

In a further embodiment, a variable which characterizes the pressure profile during the working stroke in the at least one combustion chamber is also considered as the pressure profile.

A reciprocating piston internal combustion engine according to the invention, comprising at least one cylinder, at least one piston which is mounted on the cylinder, a crank drive, at least one combustion chamber which is assigned to the at least one cylinder, preferably an inlet valve and an outlet valve per combustion chamber, a pressure sensor on the combustion chamber for detecting the pressure in the combustion chamber during a working stroke, an open-loop and/or closed-loop control unit for performing open-loop and/or closed-loop control of at least one parameter of the reciprocating piston internal combustion engine, wherein a method which is described in this patent application can be carried out.

In one variant, the reciprocating piston internal combustion engine comprises a plurality of combustion chambers and a pressure sensor is arranged on each combustion chamber. Therefore, the pressure profile can be detected for all the combustion chambers, and the energy variable per working stroke and per combustion chamber can be determined on the basis of the pressure profile.

In an additional refinement, the reciprocating piston internal combustion engine comprises a fuel tank and a fuel sensor for the fuel mixture which is contained in the fuel tank, in particular for detecting the proportion of ethanol in the fuel mixture. The data detected by the fuel sensor can be used for models and empirical values, for example for determining the conversion losses, in the described method, since the approximate proportion of the at least two types of fuel in the fuel mixture can be detected with the fuel sensor.

An exemplary embodiment of the invention is described below in more detail with reference to the appended drawings, in which:

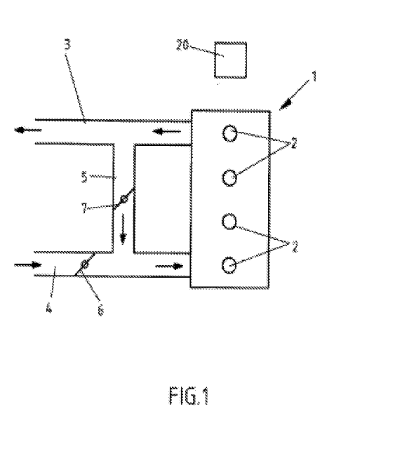

FIG. 1 shows a highly simplified illustration of a reciprocating piston internal combustion engine,

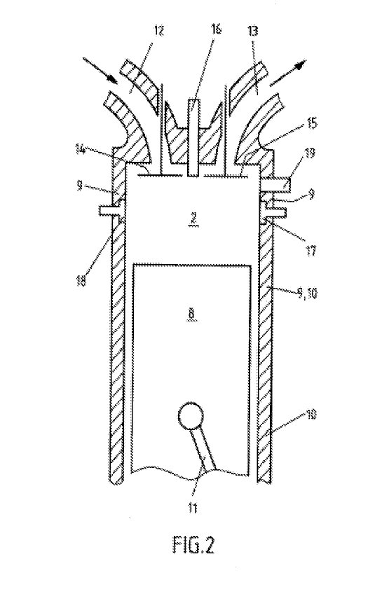

FIG. 2 shows a longitudinal section through a combustion chamber of the reciprocating piston internal combustion engine according to FIG. 1,

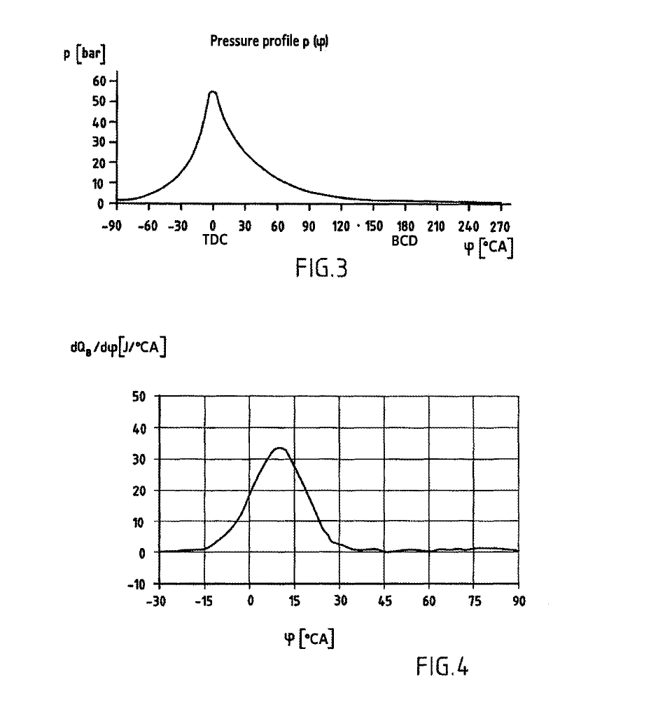

FIG. 3 shows a diagram in which the crank angle φ is plotted on the abscissa and the cylinder pressure p is plotted on the ordinate, and

FIG. 4 shows a diagram in which the crank angle φ is plotted on the abscissa and the combustion profile dQ_{B}/dφ is plotted on the ordinate.

A reciprocating piston internal combustion engine 1 which is illustrated in FIG. 1 has four combustion chambers 2. The reciprocating piston internal combustion engine 1 is operated as a spark ignition engine in what is referred to as the HCCI method, a homogenous auto-ignition method in specific operating ranges. The HCCI method is a lean combustion method and permits a reduction in consumption. The compression ratio of a spark ignition engine which is operated with gasoline is not configured for auto-ignition with a relatively high temperature. For this purpose, the reciprocating piston internal combustion engine 1 is provided with an exhaust gas recirculation line 5. Exhaust gas from the reciprocating piston internal combustion engine 1 is discharged into the surroundings through an exhaust gas line 3, and air or fresh air is fed to the reciprocating piston internal combustion engine 1 through a fresh air line 4. A fresh air valve 6 serves to perform open-loop and/or closed-loop control of the quantity of fresh air fed to the reciprocating piston internal combustion engine 1, and therefore also to perform open-loop and/or closed-loop control of the λ value. The quantity of exhaust gas which is fed from the exhaust gas line 3 to the fresh air line 4 and therefore to the reciprocating piston internal combustion engine 1 is open-loop and/or closed-loop controlled with an exhaust gas recirculation valve 7. This exhaust gas which is fed to the reciprocating piston internal combustion engine 1 makes available the necessary thermal energy in order to be able to operate the reciprocating piston internal combustion engine 1 in the HCCI method, i.e. with homogenous auto-ignition in the entire combustion chamber 2.

FIG. 2 shows a longitudinal section through a combustion chamber 2 of the reciprocating piston internal combustion engine 1. A piston 8 is supported by a cylinder 10 and carries out an oscillating translatory movement on the basis of an only partially illustrated crank drive 11 with a crankshaft and a connecting rod. The combustion chamber 2 is bounded by the piston 8 and a combustion chamber wall 9. An inlet duct 12 for conducting fresh air into the combustion chamber 2 opens into the combustion chamber 2, and an outlet duct 13 for conducting exhaust gas out of the combustion chamber 2 opens into the combustion chamber 2. An inlet valve 14 opens and closes the inlet duct 12 and has a variable valve drive, with the result that the opening times and closing times can be open-loop and/or closed-loop controlled by an open-loop and closed-loop control unit 20 independently of the crank drive 11. In the same way, the outlet valve 15 has a variable valve drive, with the result that the opening times and closing times can be open-loop and/or closed-loop controlled by an open-loop and closed-loop control unit 20 independently of the crank drive 11. A fuel mixture composed of gasoline and ethanol is fed to the combustion chamber 2 with an injector 19 during a working stroke. Outside the operation with the HCCI method, the ignition of the mixture composed of fresh air and the fuel mixture is carried out with a spark plug 16, and during the operation with the HCCI method auto-ignition is carried out. In this context, the cylinder pressure p [bar] is detected with a pressure sensor 17 in each of the four combustion chambers 2 with the result that the pressure profile p [bar] can be determined per degree crank angle φ [° CA], i.e. dp/dφ [bar/° CA]. The crank angle φ [° CA] is detected at the crankshaft as part of the crank drive 11 by an angle sensor (not illustrated). A wall temperature sensor 18 also detects the temperature of the combustion chamber wall 9 at the combustion chamber 2. In the diagram illustrated in FIG. 3, the cylinder pressure p [bar] which is plotted on the ordinate is illustrated as a function of the crank angle φ [° CA] plotted on the abscissa.

The combustion profile dQ_{B}/dφ [J/° CA] specifies the heat released during the combustion per degree of crank angle, and also contains the heat dQ_{W}/dφ [J/° CA] which flows away through the combustion chamber wall 9 and the piston 8 during combustion, in particular through the conduction of heat and radiation of heat. The heating profile dQ_{H}/dφ [J/° CA] differs from the combustion profile dQ_{B}/dφ in that the heat flowing away through the combustion chamber wall 9 and the piston 8 is not contained in the heating profile. The following therefore applies:

dQ_{B}/dφ=dQ_{H}/dφ+dQ_{W}/dφ

According to the first law of thermodynamics, the total amount of energy in a closed system is constant. The change dU of the internal energy is therefore the transmitted heat dQ and the mechanical work dW. From the first law of thermodynamics and the ideal gas equation i.e.

pV=mRT

it is possible to derive a differential equation for the system of the combustion chamber 2, and given model assumptions and/or empirically determined values and/or data detected with further sensors, for example the wall temperature sensor 18, the combustion profile dQ_{B}/dφ [J/° CA] can be calculated on the basis of the pressure profile dp/dφ [bar/° CA] detected by the pressure sensor 17. In contrast to this, the heating profile dQ_{H}/dφ [J/° CA] can be calculated from the pressure profile dp/dφ [bar/° CA]. The cumulative combustion profile Q_{B} [J] is calculated with the integral to the combustion profile dQ_{B}/dφ of a complete working stroke and contains the entire thermal energy released per working stroke per combustion chamber 2. However, the fuel mixture fed to the combustion chamber 2 per working stroke with the injector 19 contains a relatively large amount of chemical energy U_{C} since conversion losses U_{V} occur during the combustion, for example owing to incomplete combustion. The conversion losses are approx. 1 to 2% of the cumulative combustion profile Q_{B} [J] and are calculated on the basis of empirical determinations.

The open-loop and/or closed-loop control unit 20 also detects the opening time or injection time of the injector 19 per working stroke and per combustion chamber 2, and under model assumptions relating to the pressure difference and the viscosity of the fuel mixture and the known flow cross-sectional area of the injector the volume V_{K} of the fuel mixture which is fed to each combustion chamber 2 per working stroke can be calculated. The calorific value H [J/ml] of the fuel mixture composed of gasoline and ethanol is the amount of chemical energy U_{C} per volume in ml of the fuel mixture. For this reason, the calorific value H per working stroke and per combustion chamber 2 is

H=U_{C}/V_{K}=(Q_{B}+U_{V})/V_{K}

The open-loop and/or closed-loop control unit 20 therefore calculates the calorific value of the fuel mixture for each of the four combustion chambers 2 per working stroke. The parameters of the reciprocating piston internal combustion engine 1 are open-loop and/or closed-loop controlled for all of the combustion chambers 2 as a function of this calorific value, in particular using the HCCI method. For example, for this purpose the opening times of the inlet valve and outlet valve 14, 15, the injection time, in particular the injection period, of the injector 19 and the position of the fresh air valve 6 and the exhaust gas recirculation valve 7 are open-loop and/or closed-loop controlled. In this context, these parameters are implemented separately for the four combustion chambers 2 if possible since the position of the fresh air valve and exhaust gas recirculation valve 7 is effective for all the combustion chambers 2. The calorific values of the fuel mixture of a combustion chamber 2 are used only for the open-loop and/or closed-loop control of that combustion chamber 2 for which the calorific value has been calculated, i.e. separate and independent open-loop and/or closed-loop control of the parameters of the combustion chambers 2 is carried out. These parameters separately for the combustion chambers 2 are, for example, the opening times of the inlet valve and outlet valve 14, 15 and the injection times of the injector 19. Further data from the engine management system, for example relating to the rotational speed or engine temperature, can additionally also be included for the separate and independent open-loop and/or closed-loop control of the combustion chambers 2 as a function of the calorific value of the fuel mixture in one combustion chamber 2 in each case.

The reciprocating piston internal combustion engine 1 is supplied with a fuel mixture composed of gasoline and ethanol from a fuel tank (not illustrated). The fuel tank can be filled here with pure gasoline, pure ethanol or a mixture of gasoline and ethanol. Although a fuel sensor (not illustrated) for detecting the proportion of ethanol is arranged on the fuel tank, the proportion of the ethanol which is fed to the combustion chambers 2 at the injectors 19 cannot thus be detected precisely because in general completely homogenous mixture of gasoline and ethanol does not take place in the fuel tank, with the result that different fuel mixtures, in particular different as a function of the time, with different proportions of gasoline/ethanol are fed to the injectors 19 from a fuel line which opens into the fuel tank, although no type of fuel is fed to the fuel tank. Moreover, the fuel lines have different lengths from the fuel tank to the injectors 19, in particular from a high pressure rail (not illustrated) to the injectors 19, with the result that fuel mixtures with different proportions of gasoline/ethanol can also occur at the same times at the four combustion chambers 2. The fuel is sucked in from the fuel tank by a fuel pre-feed pump and fed to a high pressure pump, and is fed to the high pressure rail (not illustrated) by the high pressure pump).

Considered overall, essential advantages are associated with the method according to the invention for operating the reciprocating piston internal combustion engine 1. The open-loop and/or closed-loop control unit 20 performs open-loop and/or closed-loop control of the parameters of the combustion chambers 2 separately as a function of the calorific values, detected separately for each of the four combustion chambers 2, of the fuel mixture which is fed through the injectors 19. In this context, the parameters of the combustion chambers 2 are open-loop and/or closed-loop controlled as a function of those calorific values for which the calorific values have been determined. The reciprocating piston internal combustion engine 1 is operated in certain operating ranges with the HCCI method, which is particularly sensitive, in order to permit complete auto-ignition in the combustion chambers 2. Fluctuations in the calorific values or the proportions of gasoline/ethanol of the fuel mixture can lead to faults in the HCCI method here. Owing to the separate detection of the calorific values for each combustion chamber 2 and optimized open-loop and/or closed-loop control, separated as a function thereof, of the parameters for each combustion chamber 2, the resulting faults can be at least partially compensated, with the result that reliable operation of the reciprocating piston internal combustion engine 1 is also advantageously ensured in the HCCI method even in the case of fluctuations in the calorific values or the proportions of gasoline/ethanol of the fuel mixture which is fed to the combustion chambers 2.

1-12. (canceled)

13. A method for operating a reciprocating piston internal combustion engine, comprising the steps of
feeding a fuel mixture composed of at least two types of fuel and air into at least one combustion chamber of the reciprocating piston internal combustion engine;
burning the fuel mixture in the at least one combustion chamber during a working stroke;
detecting a pressure profile in the at least one combustion chamber during the working stroke by one pressure sensor per combustion chamber;
determining one energy variable per working stroke and per combustion chamber from the pressure profile detected by the pressure sensor, in the at least one combustion chamber, wherein the energy variable characterizes chemical energy which is released during combustion in the at least one combustion chamber;
detecting a volume and/or a mass of the fuel mixture that is fed to the at least one combustion chamber per working stroke and per combustion chamber;
determining a calorific value of the fuel mixture per working stroke and per combustion chamber from the volume and/or the mass of the fuel mixture and the determined energy variable per working stroke and per combustion chamber; and
controlling at least one parameter of the reciprocating piston internal combustion engine open-loop and/or closed-loop as a function of the determined calorific value per working stroke and per combustion chamber.

14. The method as claimed in claim 13, including determining the calorific value of the fuel mixture per working stroke and per combustion chamber separately for a plurality of combustion chambers, and at least one parameter of the reciprocating piston internal combustion engine is open-loop and/or closed-loop controlled separately for this respective combustion chamber as a function of the determined calorific values per working stroke and per combustion chamber, of which combustion chamber the calorific value has been determined, and this is carried out for a plurality of combustion chambers.

15. The method as claimed in claim 13, wherein for all the combustion chambers of the reciprocating piston internal combustion engine the calorific value of the fuel mixture per working stroke and per combustion chamber is determined separately for individual combustion chambers, and at least one parameter of the reciprocating piston internal combustion engine in all the combustion chambers is open-loop and/or closed-loop controlled separately for this respective combustion chamber as a function of the determined calorific values per working stroke and per combustion chamber, of which combustion chamber the calorific value has been determined, and this is carried out for all the combustion chambers.

16. The method as claimed in claim 13, wherein the reciprocating piston internal combustion engine is operated with auto-ignition of the fuel mixture, and/or
the reciprocating piston internal combustion engine is operated with the Otto method or with gasoline.

17. The method as claimed in claim 16, wherein the engine is operated with a HCCI method.

18. The method as claimed in claim 13, wherein the energy variable is a cumulative combustion profile and/or a cumulative heating profile.

19. The method as claimed in claim 13, wherein in order to determine the energy variable, conversion losses and/or wall heat losses are taken into account with models and/or empirical values and/or a combustion chamber wall temperature is detected and taken into account with one wall temperature sensor per combustion chamber, in order to de ermine the wall heat losses, and/or data of a heat balance probe or a Hohenberg probe are taken into account.

20. The method as claimed in claim 13, wherein, based on the calorific value of the fuel mixture per working stroke and per combustion chamber and/or based on the energy variable and the volume and/or the mass of the fuel mixture per working stroke and per combustion chamber, a proportion of the at least two different types of fuel in the fuel mixture per working stroke and per combustion chamber is determined separately for the at least one combustion chamber and as a function thereof at least one parameter of the reciprocating piston internal combustion engine is open-loop and/or closed-loop controlled separately for the at least one combustion chamber in which the proportion of the at least two different types of fuel has been determined.

21. The method as claimed in claim 20, wherein the proportion of the at least two different types of fuel in the fuel mixture per working stroke and per combustion chamber is determined separately for all the combustion chambers.

22. The method as claimed in claim 13, wherein the volume of the fuel mixture which is fed to the at least one combustion chamber for the working stroke is detected by taking into account and/or detecting an injection time and/or a pressure difference at an injector and/or a viscosity of the fuel mixture and/or a flow cross-sectional area of an injector and/or a volume flow of gaseous fuel mixture and/or inlet times of an inlet valve.

23. The method as claimed in claim 13, wherein the at least one parameter of the reciprocating piston internal combustion engine, which is open-loop and/or closed-loop controlled, is at least one of the group consisting of: an opening time of an inlet valve; an opening time of an outlet valve; a λ value; an ignition time; a quantity of fuel mixture which is fed to the combustion chamber; a quantity of air which is fed to the combustion chamber; an injection time of the fuel mixture.

24. A reciprocating piston internal combustion engine operated according to claim 13, the engine comprising:
at least one cylinder;
at least one piston mounted in the cylinder;
a crank drive;
at least one combustion chamber assigned to the at least one cylinder;
an inlet valve and an outlet valve per combustion chamber;
a pressure sensor on the combustion chamber for detecting pressure in the combustion chamber during a working stroke; and
an open-loop and/or closed-loop control unit for performing open-loop and/or closed-loop control of at least one parameter of the reciprocating piston internal combustion engine.

25. The reciprocating piston internal combustion engine as claimed in claim 24, comprising a plurality of combustion chambers and a pressure sensor is arranged on each combustion chamber.

26. The reciprocating piston internal combustion engine as claimed in claim 24, comprising a fuel tank and a fuel sensor for a fuel mixture which is contained in the fuel tank.

27. The reciprocating piston internal combustion engine as claimed in claim 26, wherein the fuel sensor is operative to detect a proportion of ethanol in the fuel mixture.
